(19) United States
(12) Patent Application Publication
(10) Pub. No.: US 2007/0250450 A1
(43) Pub. Date: Oct. 25, 2007

(54) System and method for conducting mobile transactions

(76) Inventors: Jeppe Dorff Ramlau-Hansen, San Clemente, CA (US); Kenneth Griffin, Huntington Beach, CA (US)

Correspondence Address: STETINA BRUNDA GARRED & BRUCKER, 75 ENTERPRISE, SUITE 250, ALISO VIEJO, CA, 92656, US

(21) Appl. No.: 11/407,476

(22) Filed: Apr. 20, 2006

(51) Int. Cl. G06Q 99/00

(52) U.S. Cl. 705/64

(57) ABSTRACT

A system and method for allowing a user to perform transactions between personal and/or target financial accounts via a mobile phone. The system has a user module and a system module. The user module is in the form of various types of handsets or mobile phones available in the market, and the system module has a web interface operative to interact with the user module and an administration interface allowing the administrator to perform administration action and maintain the system. A platform such as JAVA or BREW compatible to the application provided by the system module is built in the user module, and a web browser is also installed in the user module to directly access web pages or application pages generated by the web interface of the system module. Via the user module and wireless communication established between the user module and the system module, the user can easily access the service provided by the system module any time and everywhere without the requirements of a computer or a specific program provided by any financial service provider.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates in general to a system and a method for conducting mobile transactions, and more particularly, to a user interface for targeted mobile handsets allowing users to transact funds between financial accounts from wherever they are.

In the past, consumer transactions between financial accounts typically are performed on site at the consumer's bank, while simple deposits or withdrawals can also be performed at ATM machines. Recently, the development of information technology has simplified the procedure and allowed the users to perform various transactions between personal and target accounts through the Internet. However, many types of transactions are still restricted by the location of the user because accessibility of a computer and Internet is always required. There is therefore a substantial need to develop a mobile transaction system and method allowing the users to perform financial transactions between personal and target financial accounts wherever they are.

### BRIEF SUMMARY

A system and method allowing a user to perform transactions between personal and/or target financial accounts via a mobile phone is provided. The system includes a user module and a system module. The user module includes a handset such as a conventional, commercially available mobile phone, and the system module includes a web interface to interact with the user module and an administration interface allowing the administrator to perform administration actions and maintain the system. A platform such as JAVA or BREW compatible to the application provided by the system module is built in the user module, and a web browser is installed in the user module to provide direct access to the web pages or application pages generated by the web interface of the system module. Via the user module and wireless communication between the user module and the system module, the user can easily access the service provided by the system module any time and anywhere without the requirements of a computer or a specific program provided by any financial service provider.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of an exemplary mobile transaction system for providing mobile transaction service to targeted handsets;

FIG. 2 illustrates an exemplary sign-in page generated by a web interface of the mobile transaction system;

FIG. 3 shows various sign-in error messages generated by the web interface when a handset is first used to access the mobile transaction service;

FIG. 4 shows various sign-in error messages generated by the web interface when a handset has been previously used to access the mobile transaction service;

FIG. 5 shows the option allowing the user to obtain the PIN;

FIG. 6 is a main menu showing various functions provided by the mobile transaction system;

FIG. 7 shows examples for retrieving and inputting a contact list;

FIG. 8 shows examples for checking account an balance; and

FIG. 9 shows examples of funds transfer.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

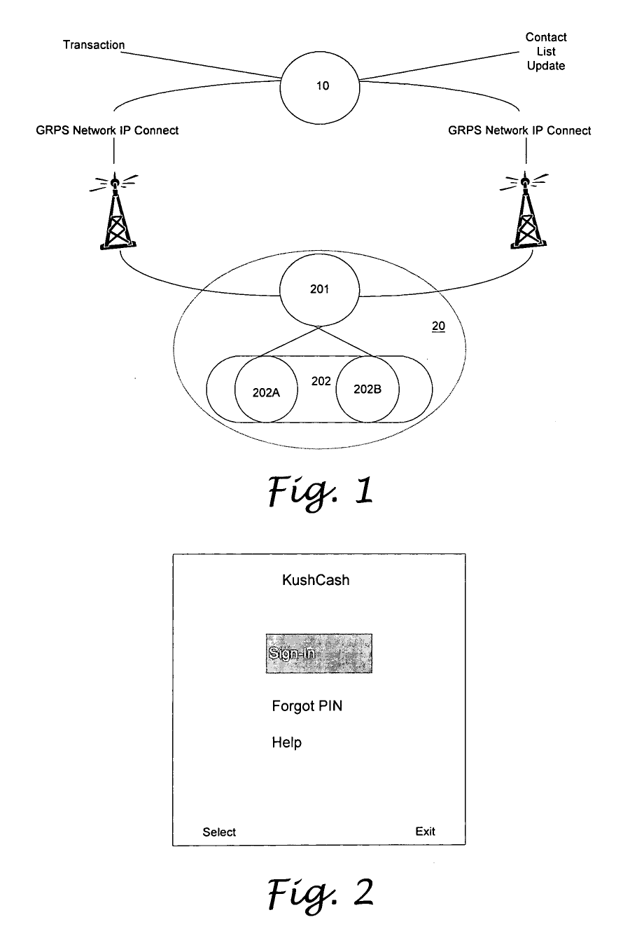

A proprietary mobile transaction service, provided in connection with the brand KushCash™, is provided to allow subscribers to transact their personal funds between personal and/or target accounts wherever they are. As shown in FIG. 1, the system includes a user module 10 allowing the user to register, sign-in, request mobile transactions, and to generate and update a contact list and a system module 20 for identifying the users, storing identification and account information for the users, and perform the transaction upon receiving the request from the registered users. The communication between the user module 10 and the system module 10 is preferably established by general packet radio service (GRPS) network. The user module 10 is preferably a handset such as a mobile phone with a built-in user interface such as a keypad allowing the user to input and a screen for displaying the information typed by the user and the information downloaded from the user module 20. Preferably, the user module 10 further comprises a built-in platform such as J2ME or BREW for running an application provided by the system module 20. The system module 20 includes a production server 201 serving as a web interface to interact with the user module 10 via the IP based GRPS network, and an administration server 202, which further includes into a unit 202A for administrating the user registration, and a unit 202B for administrating the account setup.

To subscribe to the service provided by the system module 20, the user will access a registration page generated by the registration unit 202A and transmitted by the web interface 201 of the system module 20. The registration page provides the instructions and options allowing the user to input user information required for registration. The user information typically includes a valid Email address, the MSISDN of the user module 10 or a specific handset, and a PIN (password). Upon receiving the user information, the web interface 201 may determine whether such information is accepted or rejected. Once accepted, a validation key is generated by the registration unit 202A, and an SMS message will be sent to the given MSISDN with a validation key by the web interface 201. The user may then input the validation key on the registration page to proceed further on registration. When the registration is complete, a personal account of the user is created in a database of the system module 20, and the account setup unit 202B will generate a page providing instructions and options allowing the user to input financial information such as the credit card and bank account details to the database of the system module 20. The request of information displayed by the page is then transmitted to the user module 10 via the web interface 201. In some situations an individual may be invited to register with the service in response to funds requested by or transferred from an existing user. The invited user can select whether to accept or decline the request of such fund transaction.

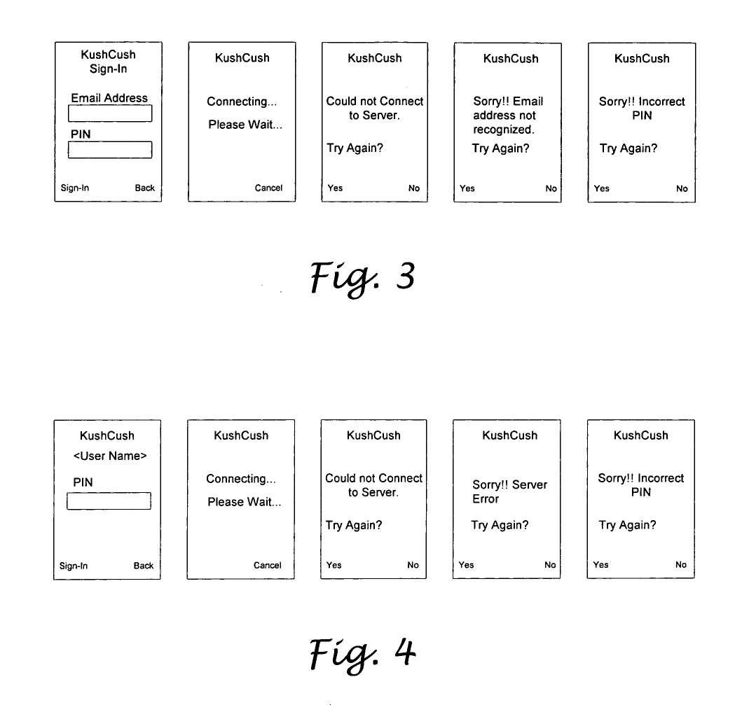

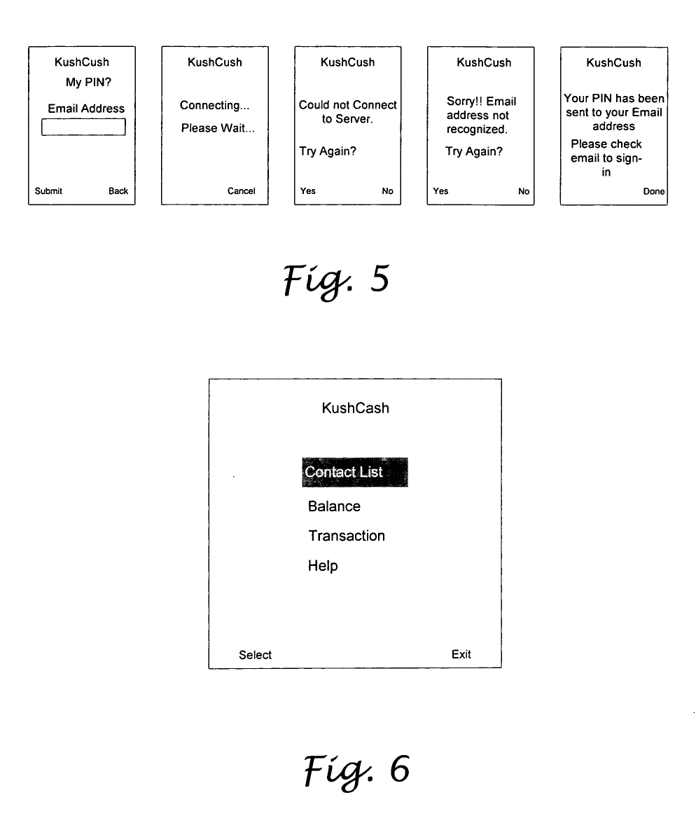

Prior to accessing the personal account or performing transactions, user authentication is required. If the user forgot his or her PIN, as shown in FIG. 2, the user may select the option of “Forgot PIN” to request the PIN information sent to the previously input email ID or MSISDN. If the user needs more operational help or decided to quit before accessing the service, the “HELP” and “Exit” options are also available in the sign-in page as shown. When a user module 10 is used for the first time to access the personal account of a registered user, both the Email address and PIN have to be input correctly to activate the service. If the registered user has previously used the same user module 10 for the service, only PIN will be required to activate the service. FIG. 3 and FIG. 4 show the exemplary sign-in page generated by the web interface 201 of the system module 20 and various error messages that possibly occur during sign-in step. When the user selects the “Forgot PIN” option, the page will show the information requesting the user to input the email address. If the email address as input is not recognized by the system or when the server cannot be connected, the PIN will be sent to the email address provided during registration. The Help option provided in the sign-in page shows the contact address such that the user may communicate with the service provider.

After successfully signing on to the system, a main menu will be generated by the user interface 201. FIG. 6 shows an exemplary main menu which provides the options of accessing contact list, balance, transaction, and help. Each of the options will be discussed in details as follows.

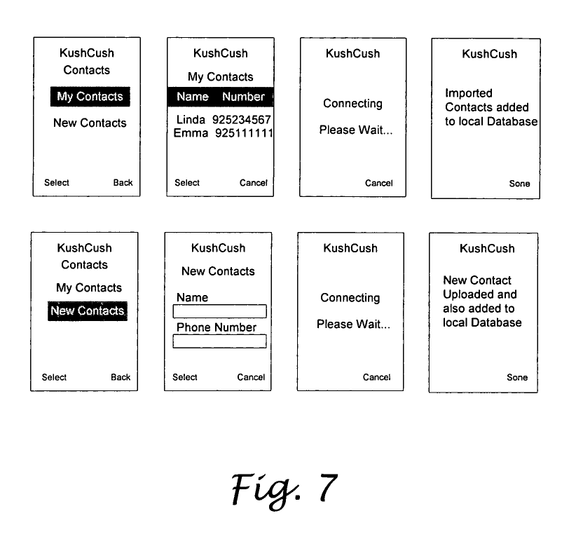

By selecting the “contact list” option, the user is allowed to input contacts information for any individual or institution as desired. The user may also select to list any specific contact information previously input and saved. FIG. 7 shows an exemplary operation of the contact list option.

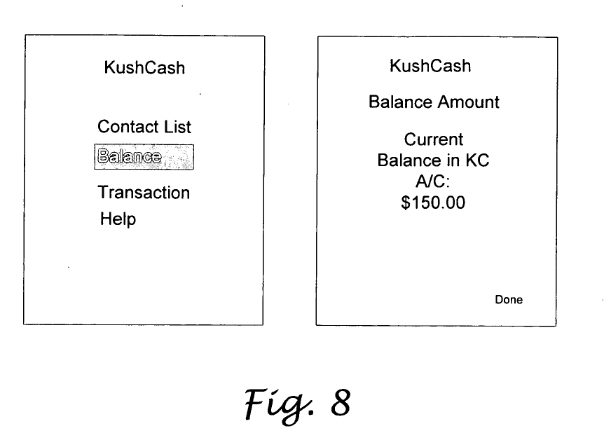

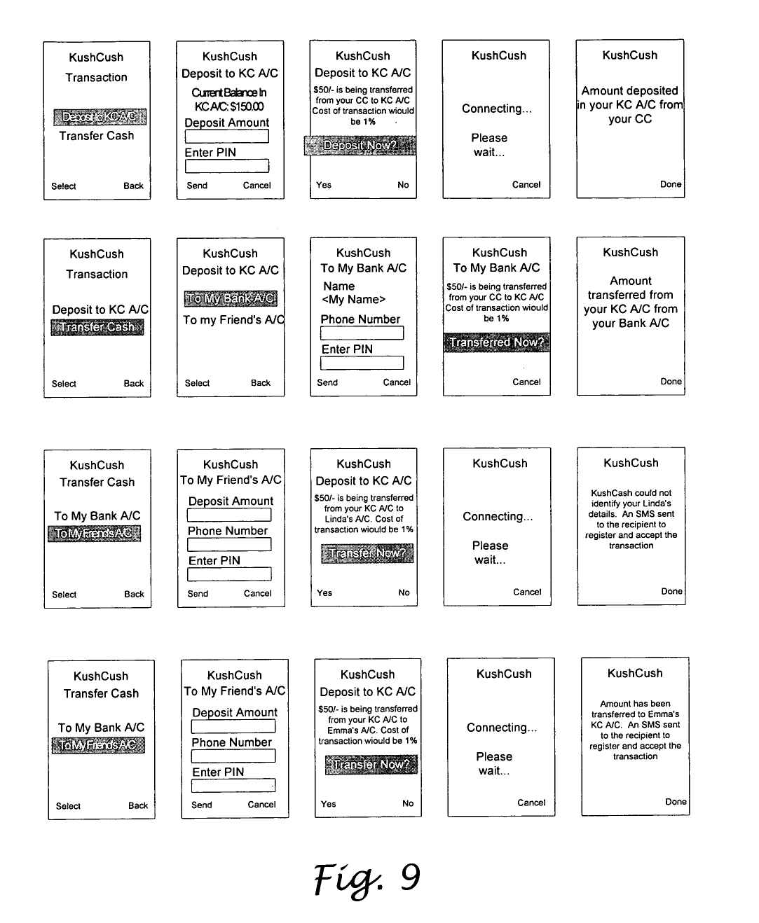

The balance option allows the user to view the current balance of his or her account. The balance can be stored in a local database of the user module 10 and updated when any transaction has been made. FIG. 8 shows an exemplary balance page provided by the service.

The application provided by the system module 20 also allows the user to transact over the service on deposit and transfer of funds. To that end, system module 20 includes a secured interface for transferring funds in the bank accounts of the user. The transaction options include several features. Firstly, the user can deposit funds from his or her previously input credit card to the system into the registered mobile account. Secondly, the user may transfer funds from his registered mobile account into the bank or other financial account previously input to the system. If the bank account does not exist, the request of transfer will be pending and an alert will be sent with an SMS message. Thirdly, the user may also transfer funds to and from an account of another individual. When the individual is not a registered user of the service, a message will be sent to this individual indicating such pending action. If the individual is a registered user of the user, a SMS message will be sent to notify the request of such fund transfer. The transfer will be performed with the permission of the individual. Various transactions that will be made available are illustrated in FIG. 9.

The system module further includes a computer to serve as a development server capable of running various operating systems, such as Linux, Microsoft Windows, Tomcat/Orion, MySQL, SSH/FTP and a computer to serve as development client capable of running a JAVA virtual machine and interacting with the development server. In addition to the computers serving as the development server and development client, the system administration module 20 further comprises software such as a secure terminal client capable of interacting with secure shell (SSH), a web browser, a JAVA development kit, and a text editor and/or Integrated Development Environment (IDE) for JAVA, HTML and Javascript, for example.¹ External systems for the software packages include Tomcat/Orion, JSP, JAVA runtime, MySQL, and a web browser. The Tomcat server is freely available from the website http://tomcat.apache.org and can run on either Microsoft Windows platform or a freely available Linux platform. The JAVA runtime can be downloaded from http://java.sun.com and is available for most of the platforms. MySQL is a freely available open source database available in http://www.mysql.com and can run on either Microsoft Windows platform or the Linux platform. The web browser is operative to interact with a web interface built in the user module.
¹I still cannot link the computers serving the development server and the computer serving the development client with the web interface and the user register unit and account setup unit as shown in FIG. 1. Please kindly advise.

Once successfully signing in, the user may be allowed to modify personal information previously input to the user module 20. For example, the MSISDN can be modified when the MSISDN is validated by the user. When the modified MSISDN is selected and input, an SMS is sent to the newly input MSISDN with a validation code, allowing the user to validate, update and activate the new MSISDN. Preferably, the user should not be allowed to modify the Email ID because certain types of user modules cannot identify the users automatically. To allow modification of the ID Email and/or the MSISDN, the user module should have a unique identification key for each user for the life time of his/her account. The key is hidden from the user but the client application of the user module. If the user successfully signs in, the server should respond the client application with the user specific unique key and each of the clients must store the key for its lifetime in its environment.

Preferably, the web interface 201 should provision the end user to download transaction history on his/her system. The user should also be allowed to download the transaction history within a specific period of time as selected. In this embodiment, the database which stores the transaction history and the user accounts is preferably running under the MySQL platform. Table 1 shows an exemplary contents of a registered user stored in the database. As shown, Table 1 includes the name of the table, the primary key indicating the specific information listed in the table, the data format of the listed information, and the description of the listed information.

TABLE 1
KcUser

| Column Name | Data Type | Description |
|---|---|---|
| UserId | Int | Unique Id that identifies a person |
| EmailId | Varchar(60) | Subscriber's personal Email Address |
| MSISDN | Varchar(30) | Subscriber's personal Cell Phone |
| | | Number |
| User Name | Varchar(30) | Subscriber's short name |
| PIN | Varchar(15) | Subscriber's system PIN as password |
| UserKey | Varchar(32) | UniqueKey on the user for Client |
| | | Applications. Encrypted code |
| FirstName | Varchar(30) | Subscriber's first name |
| MiddleName | Varchar(30) | Subscriber's middle initial or name |
| LastName | Varchar(30) | Subscriber's last name |
| Address1 | Varchar(64) | Subscriber's Address part 1 |
| Address2 | Varchar(64) | Subscriber's Address part 2 |
| HandsetId | Int | Handset model Id on a specific make |
| Account Type | Int | Designates whether a user is |
| | | registered or not. |
| | | −2 - Guest. No registered but |
| | | received funds from a KC User |
| | | −1 - Registered but update |
| | | requested is pending |
| | | 0 - Pending. Registration partly |
| | | done. Mobile or Email to be |
| | | validated. |
| | | 1 - Validated, Registered, Updated. |
| Created | Timestamp | Time of user creation |
| Last Updated | Timestamp | Time of user details modification |

As mentioned above, the database may further include a contact list of each user. The information of each person in the contact list is shown as Table 2.

TABLE 2
KCUser

| Column Name | Data type | Description |
|---|---|---|
| UserId | Int | Unique Id that identifies a person |
| ContactMSISDN | Varchar(30) | Friend's MSISDN |
| ContactEmail | Varchar(60) | Friend's personal Email Address |
| ContactName | Varchar(30) | Friend's Name |
| Created | Timestamp | Time of contact creation |
| Last Updated | Timestamp | Time of contact details modification |

Each time when the user requests a service, the service event may also be recorded and stored in the database as shown in Table 3.

TABLE 3
KCUserSessions

| Column Name | Data type | Description |
|---|---|---|
| UserId | Int | Unique Id that identifies a person |
| SessionId | Varchar(32) | An auto generated 32 character alpha |
| | | numeric string. |
| | | Unique among all sessions in the system. |
| RemoteAddr | Varchar(16) | IP of the handset or system from where |
| | | user made a request. |
| RemoteHost | Varchar(30) | Host name of the client's handset or |
| | | system |
| UserAgent | Varchar(128) | Browser/Platform name of the requested |
| | | client |
| Created | Timestamp | Time of session creation |
| Last Accessed | Timestamp | Last access time during the session |

When the user requests to update an account, the data input for such request is also stored in the database. Once the modification is validated and confirmed, the modification is then committed into the KCUsers object table. Table 4 illustrates the content to be recorded when the user requests to change PIN.

TABLE 4
KCAccountUpdates

| Column Name | Data type | Description |
|---|---|---|
| UserId | Int | Unique Id that identifies a person |
| MSISDN | Varchar(30) | Subscriber's personal Cell Phone Number |
| CurPIN | Varchar(8) | Current PIN value |
| NewPIN | Varchar(30) | New PIN as password |
| FirstName | Varchar(30) | Subscriber's first name |
| MiddleName | Varchar(30) | Subscriber's middle initial or name |
| LastName | Varachar(30) | Subscriber's last name |
| Address1 | Varachar(64) | Subscriber's address part 1 |
| Address2 | Varachar(64) | Subscriber's address part 2 |
| HandsetId | Int | Handset model Id on a specific make |
| | | Foreign Key: KCHandsets. HandsetId |
| ValidationCode | Varachar(32) | Code to validate user request |
| Account Type | Int | Designates whether a user is registered |
| | | or not |
| | | −2 - Guest. No registered but |
| | | received funds from a KC User |
| | | −1 - Registered but update |
| | | requested is pending |
| | | 0 - Pending. Registration partly |
| | | done. Mobile or Email to be |
| | | validated. |
| | | 1 - Validated, Registered, Updated. |
| Created | Timestamp | Time of Request in milliseconds |
| LastUpdated | Timestamp | Last update time of the record |

Tables 5, 6, 7, and 8 are exemplary records of credit cards information, detailed information of a specific credit card as recorded, bank information, and bank account information of the specific bank input and recorded in the database, and Table IX is the transaction information as recorded in the database.

TABLE 5
KCCreditCards

| Column Name | Data type | Description |
|---|---|---|
| CCId | Int | Unique Credit Card Id |
| CCType | Varchar(4) | Short Code for Credit Card Type: |
| | | Ex: BA; CA; AMEX; DS; DN; EN; JDB |
| CCDescription | Varchar(32) | Description for Card Type |
| | | Ex: Visa, Master Card, American Express, |
| | | Discover, Diners Clubs, enRoute, JCB |

TABLE 6
KCUserCC

| Column Name | Data type | Description |
|---|---|---|
| UserId | Int | Foreign Key on KCUsers. UserId. |
| | | Note: One User may have only one |
| | | CCId associated with. |
| CCId | Int | Foreign Key on KCCredit Cards. CCId |
| CCNumber | Varchar(16) | Subscriber's credit card number |
| ExpiryMonth | Int | Credit card expiry month |
| ExpiryYear | Int | Credit card expiry year |
| SecurityCode | Int | Security Code at the back/front of |
| | | the ard |
| Protected | Int | Pwd Protected: 1-Yes; 0-No |

TABLE 7
KCBankDetails

| Column Name | Data type | Description |
|---|---|---|
| BankId | Int | Unique Bank Id |
| BankName | Varchar(64) | Bank Name |
| Location | Varchar(64) | Location of the Bank |
| SwiftCode | Varchar(32) | Swift Code |
| ACCNum | Varchar(16) | Swift A/C Number |
| RoutingNumber | Varchar(16) | Federal Routing Number |

TABLE 8
KCUserBankAccount

| Column Name | Data type | Description |
|---|---|---|
| UBId | Int | Unique Bank Account Id for the user |
| UserId | Int | Foreign Key on KCUser. UserId |
| Bank Id | Int | Foreign Key on KCBankDetails. BankId |
| AccNumber | Varchar(30) | Bank Account number of the user |

Table 9 and shows the account information of a subscriber within the system, and Table 10 shows the details of a transaction requested by the user. As shown in Table 10, the registered users can transact fund with unregistered users of the system. Such transaction is categorized into the guest transaction before the recipient completes the registration with the system. If the recipient does not respond within a specified time period to accept or reject the transaction, the system will automatically cancel the transaction and notify the user who request the transaction.

TABLE 9
KCAccount

| Column Name | Data type | Description |
|---|---|---|
| KCId | Int | KushCash AccountId for the user |
| UserId | Int | Foreign Key on User. UserId |
| CCId | Int | Foreign Key on CreditCard CCId |
| BAId | Varchar(32) | Foreign Key on BankAccount BAId |
| Balance | Decimal(10, 2) | User's balance amount with KC |
| Created | Timestamp | Record Creation time |
| Last Updated | Timestamp | Record last updated time |

TABLE 10
KCTransactions

| Column Name | Data type | Description |
|---|---|---|
| TransId | Int | Unique Transaction Id |
| UserId | Int | Owner of the transaction. |
| | | Foreign Key: KCUser. UserId |
| RecipientId | Int | Recipient of current transaction. |
| | | −2 - not registered, |
| | | KCUser. UserId - on registration. |
| MSISDN | Varchar(30) | Recipient's Cell Phone Number |
| Amount | Decimal(10, 2) | Transaction Amount |
| TransType | Int | Deposit or Transfer |
| | | 1 - Deposit from CC to KC |
| | | 2 - Transfer from KC to Friend |
| | | 3 - Transfer from KC to Bank |
| Status | Int | 0 - Pending |
| | | 1 - Cancelled |
| | | 2 - Rejected |
| | | 3 - Accepted |
| Created | Timestamp | Time of transaction request |
| Last Updated | Timestamp | Time of transaction closure |

In addition to the fund transaction, the system also allows the user to deliver message to a recipient over SMTP or SMSC as shown in Table 11. The details with which messages have to be pushed to a recipient are listed in Tables 12 and 13.

TABLE 11
KCMesgType

| Column Name | Data type | Description |
|---|---|---|
| ServiceId | Int | Messaging Service Id |
| Service Type | Int | 0 - SMSC/SMPP, |
| | | 1 - SMTP |

TABLE 12
KCSMSC

| Column Name | Data type | Description |
|---|---|---|
| SMSCId | Int | Unique Id |
| Host | Varchar(30) | Host Name or IP Address |
| Port | Int | Access port of the host |
| GatewayDoc | Varchar(30) | Controller page on the host to |
| | | receive request |
| RequestMethod | Varchar(16) | Get or Post as applicable |
| Protocol | Varchar(8) | HTTP/1.1 |
| MimeType | Varchar(32) | Application/x-www-form-urlencoded |
| UserNameParam | Varchar(32) | Parameter name for User Name |
| UserNameValue | Varchar(32) | Parameter value for User Name |
| PwdParam | Varchar(32) | Parameter name for Password |
| PwdValue | Varchar(32) | Parameter value for Password |
| From Param | Varchar(32) | Parameter name for Sender |
| TopParam | Varchar(32) | Parameter name for Recipient |
| | | Mobile Number |
| MsgParam | Varchar(32) | Parameter name for Message Text |

TABLE 13
KCSMTP

| Column Name | Data type | Description |
|---|---|---|
| SMTPId | Int | Unique Id |
| Host | Varchar(30) | Host Name or IP Address |
| Port | Int | Access port of the host |
| MimeType | Varchar(32) | Application/x-www-form-urlencoded |
| UserName | Varchar(32) | User Name to connect to SMTP |
| Password | Varchar(32) | Password to connect to SMTP |

As listed in Table 14, all the messages to routed to the recipient should have an entry in this object, and any message sent by the system for invitations and new letters have to be logged in this object.

TABLE 14
KCUserMessage

| Column Name | Data type | Description |
|---|---|---|
| MsgId | Int | Message Id |
| UserId | Int | Sender: KCUsers. UserId |
| ToMSISDN | Varchar(30) | Recipient: If registered, it is |
| | | KCUsers. UserId |
| MessageBody | Varchar(1024) | Message to be sent |
| Status | Varchar(16) | Status on message delivery |
| | | −1 - Send failed |
| | | 0 - Pending |
| | | 1 - Sent |
| Attempts | Int | Attempts made to deliver the |
| | | message successfully |
| Created | Timestamp | Message request date |
| Last updated | Timestamp | Last updated time of the record |

TABLE 15
KCGlobalMessages

| Column Name | Data type | Description |
|---|---|---|
| MsgId | Int | Message Id |
| MSISDN | Varchar(30) | Recipient mobile phone number |
| Email | Varchar(30) | Recipient Email address |
| MsgType | Int | 0 - SMS |
| | | 1 - Email |
| MessageBody | Varchar(1024) | Message to be sent |
| Status | Varchar(16) | Status on message delivery |
| | | −1 - Send failed |
| | | 0 - Pending |
| | | 1 - Sent |
| Attempts | Int | Attempts made to deliver |
| | | Note: MAX attempts is to be defined |
| Created | Timestamp | Message request date |
| Last updated | Timestamp | Last updated time of the record |

Different carrier of the wireless internet connection may have different support on handset features, while the manufacturer and model of the handset may have different service options restricted by the carriers. For example, the carrier may decide to provide service for either BREW or J2ME on a handset which is operative to support both platforms. The selection of service depends on individual carrier. Therefore, the database is divided into three parts such as a carrier part, a handset part, and a hardware part as listed in Table 16.

TABLE 16
KCHandsets

| Column Name | Data type | Description |
|---|---|---|
| HandsetId | Int | Unique Identity of a handset |
| MakeName | Varchar(32) | Manufacturer Name |
| Model | Varchar(16) | Model name of the handset |
| Platform | Varchar(16) | Developer platform: |
| | | 1 - Sybian; 2 - PALM; |
| | | 3 - Win CE; 4 - iDen |
| | | 5 - Doja; 6 - J2ME |
| | | 7 - BREW |

In addition to the information as shown in Tables 1-16, the change of history can also be recorded in the database as shown in Table 17.

TABLE 17

| Date | Version | Comments |
|---|---|---|
| Nov. 19, 2005 | 1.0.0 | Document Creation |
| Nov. 21, 2005 | 1.0.0 | Database design details added |
| Nov. 23, 2005 | 1.0.0 | History, Request logs, transaction downloads |

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A mobile transaction system, comprising:
a mobile communication unit operative to access a wireless network and a client platform installed therein; and
a system server, comprising:
a web interface to interact with the mobile communication unit via the wireless network;
a database to store information for a registered user input by the mobile communication unit; and
an administration interface for administer an action requested by the mobile communication unit.

2. The mobile transaction system of claim 1, wherein the mobile communication unit includes a cell phone.

3. The mobile transaction system of claim 1, wherein the mobile communication unit further comprises an IP address allocated therein.

4. The mobile transaction system of claim 1, wherein the mobile communication unit further comprises a MSISDN assigned thereto.

5. The mobile transaction system of claim 1, wherein the wireless network includes GRPS network.

6. The mobile transaction system of claim 1, wherein the client platform includes J2EE or BREW.

7. The mobile transaction system of claim 1, wherein the administration interface is web browser enabled.

8. The mobile transaction system of claim 1, wherein the administration interface further comprises a user registration unit and an account setup unit.

9. A method of mobile transaction, comprising:
a) connecting a mobile communication unit with a system server through a wireless web;
b) registering to the system server and creating a personal account;
c) signing in to the system server;
d) requesting a transaction between the personal account to a bank account, an assigned account registered in the system server, or an unregistered recipient by the mobile communication unit; and
e) performing the transaction.

10. The method of claim 9, wherein step (a) further includes connecting the mobile communication unit with the system server via GRPS network.

11. The method of claim 9, further comprising downloading an application program from the system server to the mobile communication unit.

12. The method of claim 9, wherein step (b) further comprising:
inputting personal information from the mobile communication unit;
examining the personal information; and
accepting or denying the registration.

13. The method of claim 12, further comprising a step of requesting more or alternate personal information when the registration is denied.

14. The method of claim 9, wherein step (b) includes requesting input of personal identification.

15. The method of claim 9, wherein step (b) further comprising requesting input of alternate personal identification when the input personal identification is unacceptable.

16. The method of claim 9, further comprising a step of establishing a contact list.

17. The method of claim 9, wherein step (e) a step of inviting the unregistered recipient to register to the system server.

18. The method of claim 9, further comprising canceling the transaction when the unregistered recipient refused the transaction.
